(19) United States
(12) Patent Application Publication
(10) Pub. No.: US 2026/0364537 A1
(43) Pub. Date: Nov. 19, 2026

(54) MEMBRANE FILTRATION DEVICE

(71) Applicants: Mariana Hernandez Molina, Phoenix, AZ (US); Renato Martin Montenegro Ayo, Lima (PE); Sergi Garcia-Segura, Tempe, AZ (US)

(72) Inventors: Mariana Hernandez Molina, Phoenix, AZ (US); Renato Martin Montenegro Ayo, Lima (PE); Sergi Garcia-Segura, Tempe, AZ (US)

(21) Appl. No.: 19/681,517

(22) Filed: May 19, 2026

Related U.S. Application Data
(60) Provisional application No. 63/808,303, filed on May 19, 2025.

(51) Int. Cl. B01D 61/58; B01D 63/08

(52) U.S. Cl. CPC B01D 61/58; B01D 63/082; B01D 2313/025; B01D 2313/21

(57) ABSTRACT

A filtration device includes a housing and a plurality of filters. The housing is elongated and defines an interior opening along a length of the housing, an inlet at a first end of the housing configured to accept a particulate material to be filtered by the filtration device, an outlet at a second end of the housing, and a longitudinal axis along the length of the interior opening. Each filter of the plurality of filters is removably arranged transversely in the interior opening and spaced along a length of the housing. Each filter of the plurality of filters has a perimeter sized and shaped to correspond to a cross section of the interior opening and defines a multiplicity of openings. The multiplicity of openings in each filter is sized and shaped to retain particles of the multiplicity of particles above a different size threshold.

### CROSS-REFERENCE TO RELATED APPLICATION

This application claims the benefit of U.S. Patent Application No. 63/808,303 filed on May 19, 2025, which is incorporated by reference herein in its entirety.

### TECHNICAL FIELD

This invention relates to membrane filtration devices and processes.

### BACKGROUND

Overexploitation of water resources can occur when water is withdrawn at a rate faster than it can be replenished, leading to depletion and long-term damage to the aquifers and natural ecosystems. In addition, water quality is jeopardized due at least in part to increasing pollution levels.

### SUMMARY

This disclosure describes filtration devices that include a housing and a plurality of filters. An inlet at a first end of the housing is configured to receive an influent to be filtered by the filtration device. In one example, the influent is a mixture containing water and solute, particulate material, or both (e.g., contaminants). Each filter of the plurality of filters can include a multiplicity of openings (through-holes or pores) that retain particles above a size threshold. The size threshold for each filter of the plurality of filters can differ in size and shape. In some cases, the plurality of filters are additively manufactured (e.g., 3D-printed). Filtration devices equipped with the plurality of filters, each with a different pore size, can be used to illustrate how membranes of a membrane filtration system selectively retain solutes and particulate material.

In a first general aspect, a filtration device includes a housing and a plurality of filters. The housing is elongated and defines an interior opening along a length of the housing, an inlet at a first end of the housing configured to accept a particulate material to be filtered by the filtration device, an outlet at a second end of the housing, and a longitudinal axis along the length of the interior opening. Each filter of the plurality of filters is removably arranged transversely in the interior opening and spaced along a length of the housing. Each filter of the plurality of filters has a perimeter sized and shaped to correspond to a cross section of the interior opening and defines a multiplicity of openings. The multiplicity of openings in each filter is sized and shaped to retain particles of the multiplicity of particles above a different size threshold.

Implementations of the first general aspect can include one or more of the following features.

In some cases, the housing further defines a plurality of exterior openings in the perimeter of the housing in spaced-apart locations along the length of the housing, and each exterior opening is configured to accept a filter of the plurality of filters. In some implementations, each exterior opening of the plurality of exterior openings extends around at least half of the perimeter of the housing. Each filter of the plurality filters can be configured to magnetically engage with the housing. The housing can include a plurality of magnets, and each magnet of the plurality of magnets can be configured to engage with one of the filters of the plurality of filters. In certain cases, the housing is tubular. The plurality of filters can be arranged with decreasing size threshold from the first end to the second end. In some implementations, the particulate material includes a multiplicity of particles of different sizes, and each filter of the plurality of filters is configured to selectively retain particles of the multiplicity of particles above the size threshold of the filter. At least a portion of the housing can be optically transparent. Some implementations of the first general aspect further include a removable endcap configured to seal the outlet.

In a second general aspect, filtering a particulate material with the first general aspect includes providing the particulate material to the inlet and passing a portion of the particulate material through each filter of the plurality of filters, and collecting unretained particulate material at the outlet.

In a third general aspect, a kit includes the housing of the first general aspect and the plurality of filters of the first general aspect.

Implementations of the third general aspect can include one or more of the following features.

The third general aspect can further include the particulate material of the first general aspect. In some cases, the particulate material includes plastic beads. In certain implementations, the housing further includes the removable endcap.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 is a schematic diagram of an example of a pressure-driven membrane filtration system depicting the rejection of species larger than each membrane's pore size.

FIGS. 2A-2C are schematic diagrams illustrating an example of a filtration device.

FIG. 3 is a schematic diagram illustrating an example of a plurality of filters.

FIG. 4A is schematic diagram illustrating an example of a particulate material. FIG. 4B is a schematic diagram illustrating an example of a filter.

### DETAILED DESCRIPTION

This disclosure describes filtration devices that include a housing and a plurality of filters. In one example, the housing is a clear acrylic cylindrical holder, which is configured to receive a plurality of filters that represent different types of membrane filtration (e.g., microfiltration, ultrafiltration, nanofiltration and reverse osmosis).

Membranes are semi-permeable barriers that separate components of an influent by removing target species from a carrier. The target species can be a solute (e.g., dissolved in the carrier) or a particulate (e.g., suspended in the carrier). The carrier is a fluid (e.g., a liquid). A membrane is selected to retain a target species, while allowing preferential transport of the carrier. Selectivity of a membrane can be assessed by calculating the rejection rate defined by the percentage of a target species that is retained by a membrane. In an example, the target species is a salt, and the salt rejection percentage of a reverse osmosis system can be measured using Equation 1, where Cₚₑᵣₘ and C_{feed} are the conductivity in the permeate and feed, respectively.

$$Salt rejection ( \% ) = ( 1 - \frac{{C}_{p e r m}}{{C}_{feed}} ) \times 100 \qquad ( 1 )$$

Membrane filtration technologies typically employ organic polymeric or inorganic ceramic materials to drive physical separations. Effective separations typically rely on the molecular size-exclusion mechanism, which enables separation of microorganisms, organic compounds, heavy metals, and inorganic salts (e.g., sodium chloride). The capacity and performance of each specific membrane is determined at least in part by the permeability and selectivity properties of the membrane material.

Membrane permeability relates to the ability of the membrane to allow substances to pass through it, and can be measured in terms of flux (volume of filtered fluid through a unit area of membrane per unit time [L m⁻² h⁻¹]). Membrane selectivity is determined by chemical composition and physical structure of the membrane material.

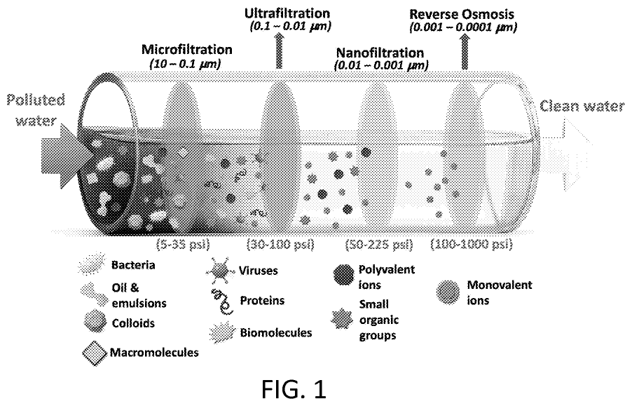

FIG. 1 is a schematic diagram of an example of a pressure-driven membrane filtration system depicting the rejection of species larger than the pore size of each membrane. Membrane filtration is typically a pressure-driven process, in which the influent is forced to pass through the membrane, generating a permeate with lower content of target species and a rejection stream that contains higher concentrations of target species. Depending on the operation conditions, the membrane separation processes can be classified as low-pressure processes (e.g., <60 psi) or high-pressure processes (e.g., >60 psi). Microfiltration and ultrafiltration processes typically operate under lower applied pressures (e.g., 5 psi to 100 psi), while nanofiltration and reverse osmosis processes typically use higher applied pressures (e.g., 50 psi to 1000 psi), as shown in FIG. 1. The membrane type and pressure applied vary depending on the type of influent being treated (e.g., sea water, fresh water, brackish water). In some cases, certain influents include higher concentrations of contaminants (e.g., sea water with high salt concentrations of >30 g/L). Filtration of these influents typically involves high-pressure membranes (e.g., reverse osmosis membranes) to separate out the contaminants. In other cases, the influent being treated contains lower contaminant concentrations (e.g., freshwater). Lower pressures are typically used for the filtration of less contaminated influent due at least in part to the reduced overall contaminant concentration.

The pore size range, separation mechanism, and contaminant rejection of each membrane process can differ, as shown in Table 1. Membrane processes utilizing membranes with a larger average pore size (e.g., microfiltration with an average pore size in a range of 100-10,000 nm) can remove contaminants including bacteria, suspended solids, and colloids. As the size of the contaminant decreases, membranes with smaller pore sizes are used to reject the contaminants. For example, saline influents (e.g., brackish water and seawater) contain high concentration of ionic species that can be removed by reverse osmosis to generate potable water. Reverse osmosis is effective in desalination at least in part because the pore size of the reverse osmosis membrane can remove small contaminants, including differently charged ions. Nanofiltration processes can remove small organics, macromolecules, viruses, proteins, divalent ions, micropollutants, and pharmaceuticals and personal care products. Pharmaceutical and personal care products can include hormones, caffeine, and antibiotics. Some implementations of a membrane filtration process include pretreating the influent with a low-pressure membrane process (e.g., microfiltration and ultrafiltration) to remove larger contaminants, and subsequently treating the influent with high-pressure processes.

TABLE 1
Characteristics of membrane processes.

| | Micro- | Ultra- | Nano- | Reverse |
|---|---|---|---|---|
| | filtration | filtration | filtration | Osmosis |
| Pressure range | 5-30 | 15-100 | 50-225 | 10-1200 |
| (psi)* | | | | |
| Pore size range | 100-10,000 | 2-100 | 0.5 | <0.5 |
| (nm)* | | | | |
| Can reject | Yes | Yes | Yes | Yes |
| bacteria, | | | | |
| suspended solids, | | | | |
| colloids | | | | |
| Can reject | No | Yes | Yes | Yes |
| macromolecules, | | | | |
| viruses, proteins | | | | |
| Can reject | No | No | Yes | Yes |
| divalent ions, | | | | |
| micropollutants, | | | | |
| small organics | | | | |
| Can reject | No | No | No | Yes |
| monovalent ions | | | | |

*Typical average values

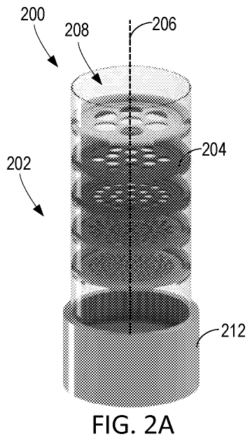

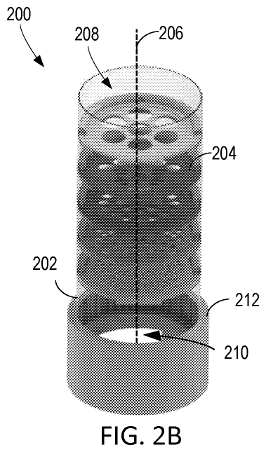

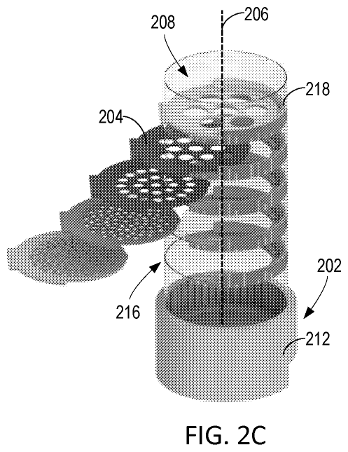

A filtration device equipped with a plurality of filters with different pore sizes can be used to demonstrate how various membranes of a membrane filtration system selectively retain solutes. FIGS. 2A-2C are schematic diagrams showing an example of an instructional filtration device 200. The filtration device 200 includes a housing 202 and a plurality of filters 204.

The housing 202 is tubular. At least a portion of the housing 202 is optically transparent. The housing 202 is elongated and defines an interior opening along a length of the housing 202 and a longitudinal axis 206 along the length of the interior opening. An inlet 208 at a first end of the housing 202 is configured to accept an influent to be filtered by the filtration device 200. The housing 202 defines an outlet 210 at a second end of the housing 202. The filtration device 200 further includes a removable endcap 212 configured to seal the outlet 210.

Each filter of the plurality of filters 204 is removably arranged transversely in the interior opening and spaced along a length of the housing 202. Each filter of the plurality of filters 204 has a perimeter sized and shaped to correspond to a cross section of the interior opening. Each filter of the plurality of filters 204 defines a multiplicity of openings (e.g., of same or different diameters).

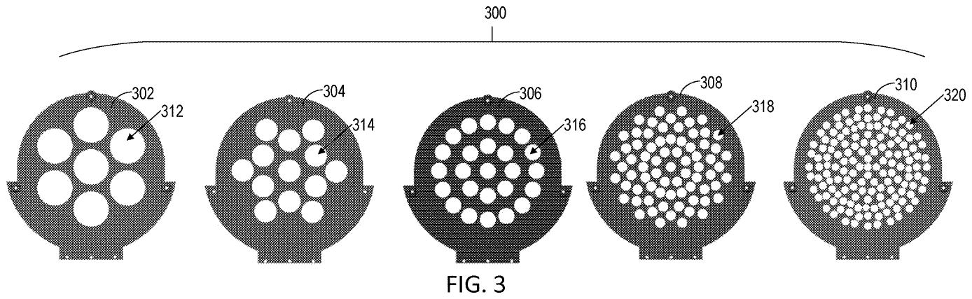

FIG. 3 is a schematic diagram of an example of a plurality of filters 300. The plurality of filters 300 includes a first filter 302, a second filter 304, a third filter 306, a fourth filter 308, and a fifth filter 310. The first filter 302 includes a multiplicity of openings 312. The second filter 304 includes a multiplicity of openings 314. The third filter 306 includes a multiplicity of openings 316. The fourth filter 308 includes a multiplicity of openings 318. The fifth filter 310 includes a multiplicity of openings 320. The multiplicity of openings in each filter of the plurality of filters 300 is sized and shaped to retain particles above a different size threshold. In some implementations, the plurality of filters includes more than five filters or less than five filters. The size of the multiplicity of openings in each filter of the plurality of filters can be selected to represent different types of filtration (e.g., sand filtration, microfiltration, ultrafiltration, nanofiltration, reverse osmosis).

Referring to FIG. 2C, the housing 202 further defines a plurality of exterior openings 216 in the perimeter of the housing 202 in spaced-apart locations along the length of the housing 202. Each exterior opening of the plurality of exterior openings 216 is configured to accept a filter of the plurality of filters 204. Each exterior opening of the plurality of exterior openings 216 extends around at least half of the perimeter of the housing 202. Each filter of the plurality filters 204 is configured to magnetically engage with the housing 202. The housing 202 includes a plurality of magnets 218. Each magnet of the plurality of magnets 218 is configured to engage with one of the filters of the plurality of filters 204.

The plurality of filters 204 is arranged with decreasing size threshold from the first end to the second end of the housing 202. This arrangement of the plurality of filters 204 allows larger particles of the particulate material to be removed before reaching filters that include a multiplicity of openings with smaller sizes. Clogging of the plurality of filters 204 can be reduced and a desired flow rate of the particulate material across the filtration device 200 is maintained.

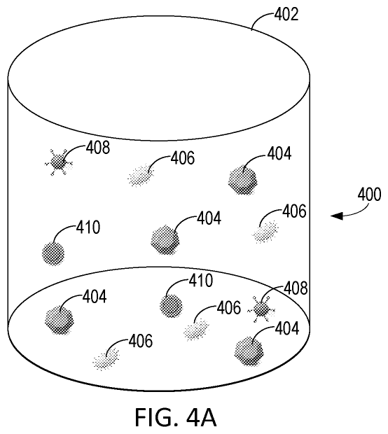

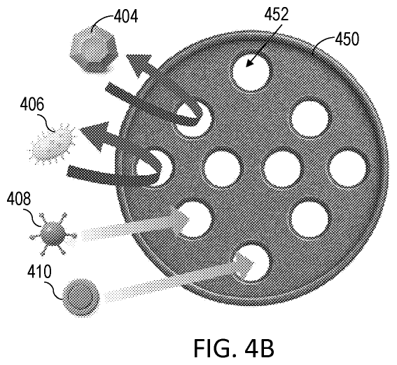

FIG. 4A is a schematic diagram illustrating an example of a particulate material 400 in a container 402 (e.g., the particulate material to be filtered by the instructional filtration device 200). The particulate material 400 includes a multiplicity of particles. The multiplicity of particles includes first particles 404, second particles 406, third particles 408, and fourth particles 410. The particulate material 400 can include additional particles. In some cases, at least a portion of the multiplicity of particles in the particulate material 400 differ from one other in size and shape. In some cases, at least a portion of the multiplicity of particles in the particulate material 400 are the same particles. In certain implementations, all particles of the multiplicity of particles are the same particles.

FIG. 4B is a schematic diagram illustrating an example of a filter 450 rejecting a particulate material 400 based on size exclusion for instructional (e.g., educational) purposes. The particulate material 400 includes a multiplicity of particles of different sizes. The filter 450 includes a multiplicity of openings 452 configured to receive an influent containing the particulate material 400 (carrier not shown) and selectively retain particles of the multiplicity of particles above the size threshold of the filter 450. The filter 450 is configured to retain the first particles 404 and the second particles 406 while allowing the third particles 408 and the fourth particles 410 to pass through the multiplicity of openings 452 of the filter 450.

Filtering a particulate material with the filtration device 200 includes providing an influent containing the particulate material (e.g., the particulate material 400) to the inlet 208, passing a portion of the particulate material through each filter of the plurality of filters 204, and collecting carrier and the unretained particulate material at the outlet 110.

Some implementations include a kit including the housing 202 and the plurality of filters 204. The kit can further include the particulate material (e.g., the particulate material 400). In some cases, the particulate material includes plastic beads (e.g., as a carrier). The kit can further include the removable endcap 212.

### EXAMPLES

A filtration system with a plurality of filters was constructed. Each filter of the plurality of filters included a multiplicity of openings. The filtration system included five filters representing sand filtration, microfiltration, ultrafiltration, nanofiltration, and reverse osmosis processes. The five filters were coupled to a cylindrical housing to emulate the physical barrier constructed in a membrane filtration system. The acrylic cylindrical housing was manually cut to yield a plurality of exterior openings that were each configured to receive and house the five filters. Each filter was 3D-printed using a polylactic acid filament, and included an area to insert and attach magnets. Each filter was held in place in the cylindrical housing by a circular magnet inserted on a side of each filter. This configuration allowed for movement and re-arrangement of the different filters while illustrating aspects regarding permeability, selectivity, and fouling.

Various objects were used to represent a carrier (e.g., water) and target species (e.g., pollutants): ping pong balls (representing large particles), four differently sized wooden beads (representing colloids and three different-charge ions), pompoms (representing viruses), pipe cleaners (representing bacteria), and small plastic beads (representing water molecules). The bacteria were made by twisting a piece of pipe cleaner around a pompom, and the different ions were painted in different colors to avoid confusion. In some cases, the particulate matter and water molecules were placed separately in containers. In certain cases, the particulate matter and the water molecules were mixed to provide a closer approximation of contaminated water.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A filtration device comprising:
a housing, wherein the housing is elongated and defines:
an interior opening along a length of the housing;
an inlet at a first end of the housing configured to accept a particulate material to be filtered by the filtration device, wherein the particulate material comprises a multiplicity of particles;
an outlet at a second end of the housing; and
a longitudinal axis along the length of the interior opening; and
a plurality of filters removably arranged transversely in the interior opening and spaced along a length of the housing, each filter of the plurality of filters having a perimeter sized and shaped to correspond to a cross section of the interior opening and defining a multiplicity of openings, wherein the multiplicity of openings in each filter is sized and shaped to retain particles of the multiplicity of particles above a different size threshold.

2. The filtration device of claim 1, wherein the housing further defines a plurality of exterior openings in the perimeter of the housing in spaced-apart locations along the length of the housing, and each exterior opening is configured to accept a filter of the plurality of filters.

3. The filtration device of claim 2, wherein each exterior opening of the plurality of exterior openings extends around at least half of the perimeter of the housing.

4. The filtration device of claim 2, wherein each filter of the plurality of filters is configured to magnetically engage with the housing.

5. The filtration device of claim 4, wherein the housing comprises a plurality of magnets, each magnet of the plurality of magnets is configured to engage with one of the filters of the plurality of filters.

6. The filtration device of claim 1, wherein the housing is tubular.

7. The filtration device of claim 1, wherein the plurality of filters is arranged with decreasing size threshold from the first end to the second end.

8. The filtration device of claim 7, wherein the particulate material comprises a multiplicity of particles of different sizes, and each filter of the plurality of filters is configured to selectively retain particles of the multiplicity of particles above the size threshold of the filter.

9. The filtration device of claim 1, wherein at least a portion of the housing is optically transparent.

10. The filtration device of claim 1, further comprising a removable endcap configured to seal the outlet.

11. A method of filtering a particulate material with the filtration device of claim 1, the method comprising:
providing the particulate material to the inlet;
passing a portion of the particulate material through each filter of the plurality of filters; and
collecting unretained particulate material at the outlet.

12. A kit comprising:
the housing of claim 1; and
the plurality of filters of claim 1.

13. The kit of claim 12, further comprising the particulate material of claim 1.

14. The kit of claim 13, wherein the particulate material comprises plastic beads.

15. The kit of claim 12, wherein the housing further comprises the removable endcap of claim 10.
